(19) United States
(12) Patent Application Publication
(10) Pub. No.: US 2010/0224164 A1
(43) Pub. Date: Sep. 9, 2010

(54) CRANKSHAFT FOR A VARIABLE COMPRESSION RATIO ENGINE

(76) Inventor: Vianney Rabhi, Lyon (FR)

Correspondence Address: YOUNG & THOMPSON, 209 Madison Street, Suite 500, Alexandria, VA, 22314, US

(21) Appl. No.: 12/160,310

(22) PCT Filed: Jan. 26, 2007
(86) PCT No.: PCT/FR07/00148

§ 371 Date: Jan. 8, 2009

Related U.S. Application Data
(60) Provisional application No. 60/762,868, filed on Jan. 30, 2006.

(30) Foreign Application Priority Data
Jan. 26, 2006 (FR) 06/00711

(51) Int. Cl. F02B 75/32; F01M 1/02

(52) U.S. Cl. 123/197.4; 123/196 R

(57) ABSTRACT

The invention relates to a crankshaft (9) for a variable compression ratio engine, which can be used to convert the reciprocating motion of the main moving components (2, 3, 5, 6, 40) of the variable compression ratio engine into rotational motion. The inventive device, which includes hydrodynamic bearings, has no balance weights.

The present invention relates to a crankshaft for a variable volumetric ratio engine that is supported by hydrodynamic bearings.

International patents WO98/51911, WO00/31377, WO03/008783, belonging to the Applicant, disclose various mechanical devices for a variable volumetric ratio engine.

It will be seen that international patent WO98/51911, in the name of the Applicant, describes a device which serves to improve the overall efficiency of internal combustion piston engines used at variable load and speed by adapting their effective displacement and/or their volumetric ratio during operation.

It will be observed from international patents WO00/31377 and WO03/008783, in the name of the Applicant, that the mechanical transmission device for a variable volumetric ratio engine comprises at least one cylinder in which there moves a piston which is secured, in its lower portion, to a transmission member which cooperates, on the one hand, by means of one small-sized rack, with a rolling guide device and, on the other hand, by means of another large-sized rack, with a toothed wheel secured to a connecting rod, this making it possible to transmit the movement between said piston and said connecting rod.

The mechanical transmission device for a variable volumetric ratio engine also comprises at least one control rack which cooperates with the toothed wheel, means for fastening the piston to the transmission member that offer a clamping preload, connection means which make it possible to stiffen the teeth of the racks, and means for reinforcing and lightening the structure of the toothed wheel.

It will be observed that the piston, secured in its lower portion to a transmission member, and the toothed wheel operate with a reciprocating movement and are coupled to a crankshaft by the connecting rod, said crankshaft and said connecting rod having the effect of converting said reciprocating movement of said piston and said wheel into rotational movement.

It will be noted that all the international patents in the name of the Applicant relating to the variable volumetric ratio engine describe a crankshaft which, as is the case for conventional crankshafts, comprise balance masses.

It will be gathered that the transmission member secured to the piston and the control rack of the variable volumetric ratio engine have a considerable width which makes it necessary to space apart the cylinders so that the balance masses of the crankshaft can pass on either side of said transmission member and said control rack.

As a result of this necessity, the longitudinal space requirement and the weight of the engine are significantly increased. Furthermore, spacing apart the cylinders increases the total length of the crankshaft, with the consequence of increasing its deflection when it is deformed under the effect of the load which is applied to it.

With the aim of significantly reducing the longitudinal space requirement and the weight of the variable volumetric ratio engine, the crankshaft intended for said variable volumetric ratio engine according to the present invention is distinguished from the prior art in that, according to one particular embodiment:
the manufacture of the crankshaft is simplified;
the length and the weight of the crankshaft are reduced;
the distance between the various cylinders of the variable volumetric ratio engine is comparable to the distance between the various cylinders of a conventional fixed volumetric ratio engine of the same bore;
the longitudinal space requirement of the variable volumetric ratio engine is comparable to that of a conventional fixed volumetric ratio engine of the same bore;
the weight of the variable volumetric ratio engine is reduced.

The crankshaft for a variable volumetric ratio engine according to the present invention makes it possible to convert the reciprocating movement of the main moving components of said variable volumetric ratio engine into rotational movement, comprises hydrodynamic bearings and is devoid of balance masses.

The crankshaft for a variable volumetric ratio engine according to the present invention comprises at least one crankpin coupled to at least one connecting rod of the variable volumetric ratio engine on the one hand, and at least two journals and an axial stop bearing formed in the engine block of said engine on the other hand.

The crankshaft for a variable volumetric ratio engine according to the present invention comprises hydrodynamic bearings which consist of a smooth cylindrical surface formed on said crankshaft and which rotate in bushings.

The crankshaft for a variable volumetric ratio engine according to the present invention comprises hydrodynamic bearings which are lubricated by pressurized oil supplied by ducts formed within the mass of said crankshaft on the one hand, and within the mass of the engine block on the other hand.

The crankshaft for a variable volumetric ratio engine according to the present invention comprises ducts formed within the mass of said crankshaft which communicate with orifices which open onto each of the smooth cylindrical surfaces which make up the hydrodynamic bearings of said crankshaft.

The crankshaft for a variable volumetric ratio engine according to the present invention comprises at least one pulley for rotationally driving the timing system and the peripherals of the engine.

The crankshaft for a variable volumetric ratio engine according to the present invention comprises at least one flywheel for connecting the engine to a gearbox.

The description which follows with reference to the appended drawings, which are given by way of nonlimiting examples, will allow a better understanding of the invention, the features which it displays and the advantages that it can provide:

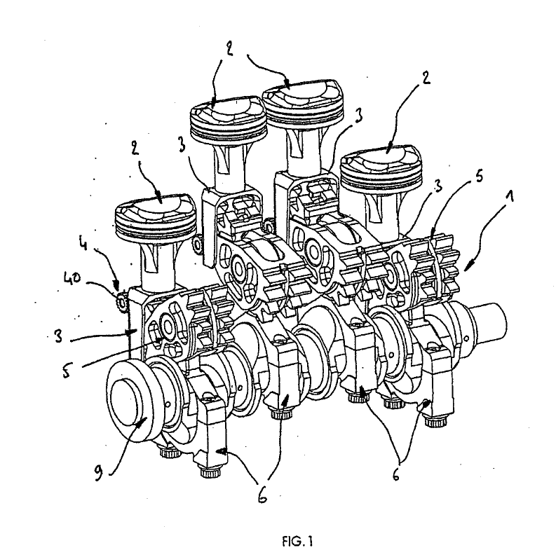

FIG. 1 is a perspective view illustrating the crankshaft for a variable volumetric ratio engine supported by hydrodynamic bearings according to the present invention, said crankshaft being coupled to the moving components of the variable volumetric ratio engine that are subjected to a reciprocating movement.

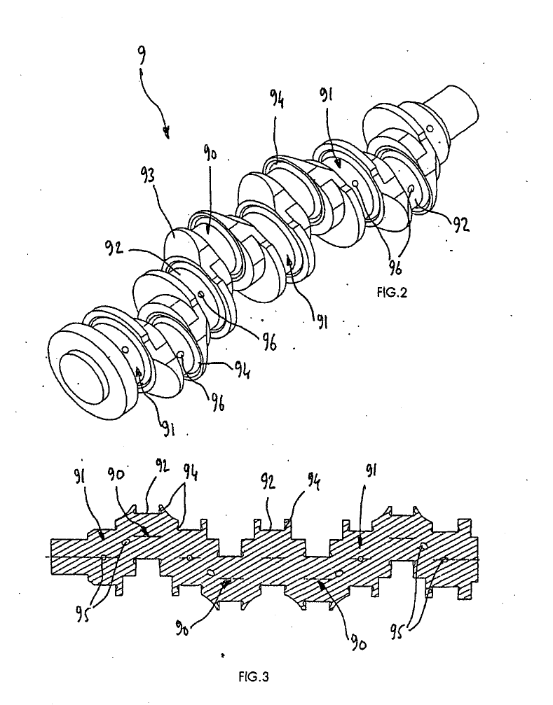

FIG. 2 is a perspective view showing the crankshaft according to the present invention.

FIG. 3 is a sectional view representing the crankshaft according to the present invention.

FIG. 1 shows the main moving components of a variable volumetric ratio engine, of which can be seen at least one piston 2 whose reciprocating movement is converted into rotational movement by means of a transmission device 1.

Said mechanical transmission device 1 comprises, in the lower portion of the piston 2, a transmission member 3 secured to said piston which cooperates, on the one hand, with a rolling guide device 4 and, on the other hand, with a toothed wheel 5. Said toothed wheel 5 cooperates with a connecting rod 6 coupled to a crankshaft 9, the subject of the present invention, in order to transmit the work provided by the piston 2, which is moved with a reciprocating movement, to said crankshaft 9, which is moved with a rotational movement.

On the opposite side to the transmission member 3, the toothed wheel 5 cooperates with another rack (not shown), termed control rack, whose vertical position with respect to the engine block is governed by a control device comprising a control jack.

Thus, the crankshaft 9 for a variable volumetric ratio engine makes it possible to convert into rotational movement the reciprocating movement of the main moving components of said engine consisting of at least one piston 2 and its transmission member 3, the toothed wheel 5 coupled to its connecting rod 6, and a synchronized roller 40, said synchronized roller 40 forming part of the rolling guide device 4.

According to one particular embodiment, the crankshaft 9 can be made of cast iron or of steel, and it can be cast, forged or completely machined within the mass of a block of metal.

The crankshaft 9 comprises at least one crankpin 90 coupled to the connecting rod 6 of the variable volumetric ratio engine on the one hand, and at least two journals 91 and an axial stop bearing (not shown) formed in the engine block of said engine on the other hand.

The crankshaft 9 comprises hydrodynamic bearings which each consist of a smooth cylindrical surface 92 formed on said crankshaft and rotating in bushings (not shown).

Moreover, the crankshaft 9 for a variable volumetric ratio engine is devoid of balance masses.

The bushings, known per se, can have a steel back covered by antifriction metal.

According to one particular embodiment, the smooth cylindrical surface 92 which constitutes the hydrodynamic bearings can be nitrided or case-hardened.

The smooth cylindrical surface 92 of each hydrodynamic bearing is connected to the webs 93 of the crankshaft 9 by connecting radiuses or grooves 94.

The connecting radiuses or grooves 94 can be produced by roller burnishing or by machining.

The crankshaft 9 comprises hydrodynamic bearings which are lubricated by pressurized oil supplied by ducts 95 formed within the mass of said crankshaft on the one hand, and within the mass of the engine block on the other hand.

The crankshaft 9 comprises ducts 95 formed within the mass of said crankshaft and communicating with orifices 96 which open onto each of the smooth cylindrical surfaces 92 which make up the hydrodynamic bearings of said crankshaft.

The crankshaft 9 for a variable volumetric ratio engine comprises at least one pulley for rotationally driving the timing mechanism and the peripherals of the engine.

The pulley can incorporate a damper known per se used to reduce the vibration emissions.

The crankshaft 9 comprises at least one flywheel for connecting the engine to a gearbox. The flywheel can also comprise a ring gear which cooperates with the output pinion of an electric starter.

It must moreover be understood that the foregoing description has been given purely by way of example and that it in no way limits the field of the invention from which there would be no departure if the implementation details described were replaced by any other equivalent.

1. A crankshaft for a variable volumetric ratio engine which makes it possible to convert the reciprocating movement of the main moving components (2, 3, 5, 6, 40) of said variable volumetric ratio engine into rotational movement, characterized in that it comprises hydrodynamic bearings and in that it is devoid of balance masses.

2. The crankshaft for a variable volumetric ratio engine as claimed in claim 1, characterized in that it comprises at least one crankpin (90) coupled to a connecting rod (6) of the variable volumetric ratio engine on the one hand, and at least two journals (91) and an axial stop bearing formed in the engine block of said engine on the other hand.

3. The crankshaft for a variable volumetric ratio engine as claimed in claim 1, characterized in that the hydrodynamic bearings consist of a smooth cylindrical surface (92) formed on said crankshaft and rotating in bushings.

4. The crankshaft for a variable volumetric ratio engine as claimed in claim 1, characterized in that the hydrodynamic bearings are lubricated by pressurized oil supplied by ducts (95) formed within the mass of said crankshaft on the one hand, and within the mass of the engine block on the other hand.

5. The crankshaft for a variable volumetric ratio engine as claimed in claim 3, characterized in that the hydrodynamic bearings are lubricated by pressurized oil supplied by ducts (95) formed within the mass of said crankshaft on the one hand, and within the mass of the engine block on the other hand, and the ducts (95) formed within the mass of the crankshaft (9) communicate with orifices (96) which open onto each of the smooth cylindrical surfaces (92) which make up the hydrodynamic bearings of said crankshaft.

6. The crankshaft for a variable volumetric ratio engine as claimed in claim 1, characterized in that it comprises at least one pulley for rotationally driving the timing system and the peripherals of the engine.

7. The crankshaft for a variable volumetric ratio engine as claimed in claim 1, characterized in that it comprises at least one flywheel for connecting the engine to a gearbox.
